(19) United States
(12) Patent Application Publication
(10) Pub. No.: US 2015/0204297 A1
(43) Pub. Date: Jul. 23, 2015

(54) STARTER

(71) Applicant: DENSO CORPORATION, Kariya-city (JP)

(72) Inventors: Tasuku YAMADA, Kariya-shi (JP); Tomoya IMANISHI, Obu-shi (JP)

(21) Appl. No.: 14/601,896

(22) Filed: Jan. 21, 2015

(30) Foreign Application Priority Data
Jan. 23, 2014 (JP) 2014-010062

(51) Int. Cl. F02N 15/06; F16H 55/17

(52) U.S. Cl. CPC F02N 15/067; F16H 55/17

(57) ABSTRACT

A washer is held by being sandwiched in an axial direction by a pinion and a holder. Here, although the washer is inexpensive, it has high planar accuracy. Then, by sandwiching the washer in the axial direction between the pinion and the holder, a metal surface of the inexpensive washer with high planar accuracy can be used as a contacting surface that contacts a holder side slide-contacting surface directly. Furthermore, another metal surface of the washer can also be directly contacted to a pinion side slide-contacting surface. Thereby, wear caused by a slide-contacting rotation of the holder can be reduced without raising costs of parts and processing in the starter that adopts a pinion shift structure.

### CROSS-REFERENCE TO RELATED APPLICATION

This application is based on and claims the benefit of priority from earlier Japanese Patent Application No. 2014-010062 filed Jan. 23, 2014, the description of which is incorporated herein by reference.

### TECHNICAL FIELD

The present disclosure relates to a starter that puts an internal-combustion engine into operation.

### BACKGROUND

A starter with a pinion that transmits torque from an electric motor to a ring gear of an internal-combustion engine, and engages the pinion to the ring gear by shifting a shift lever with a force of an electromagnetic switch is commonly known.

Moreover, there exists a holder etc. that supports an end of the shift lever as a component driven by the shift lever in addition to the pinion. By the end of the shift lever pushing the holder and then the holder pushing the pinion, the pinion and the holder, etc. are united and driven in an axial direction (hereafter, a group of the components driven by the shift lever may be batched and called a pinion moving body.).

In addition, the holder has a structure that does not rotate relative to the shift lever.

As a mass of the pinion moving body becomes larger, it is necessary to make the force of the electromagnetic switch stronger.

For this reason, a structure that does not include a metal pinion tube in the pinion moving body and that makes it lightweight by manufacturing the holder by using resin (it is hereafter called a pinion shift structure) is advantageous because it can miniaturize the electromagnetic switch.

When the pinion shift structure is adopted, an area of an end surface, opposite to the ring gear side of the pinion where tooth tips are formed, faces and contacts an end surface of the holder in an axial direction.

For this reason, when the ring gear rotates at high speed due to the starting of the internal-combustion engine and the pinion engaged with the ring gear also reaches high speed, the pinion rotates and slide-contacts to the holder in which the rotation is restricted (refer to Japanese Patent Application Laid-Open Publication No.2008-115743, for example).

In addition, in the following explanation, in each of the pinion and the holder, surfaces facing other faces in the axial direction that rotate and slide-contact may be called a pinion side slide-contacting surface and a holder side slide-contacting surface, respectively.

Moreover, the pinion side slide-contacting surface is a metal surface, and the holder side slide-contacting surface is a resin surface.

When a slide-contacting rotation with a large rotating speed difference occurs between the metal pinion and the resin holder, the holder side slide-contacting surface wears out and an engaging distance of the pinion and the ring gear becomes out of a preset range.

For this reason, a structure that reduces a frictional torque due to the slide-contacting rotation between the holder and the pinion by disposing a bearing between the holder and the pinion is disclosed in the Publication No.'743.

Moreover, as a method of suppressing the wear of the holder side slide-contacting surface by reducing the frictional torque other than disposition of the bearing, reducing a surface pressure by increasing planar accuracy and reducing a slide-contacting area of the pinion side slide-contacting surface has also been considered.

However, the cost of parts increases by providing the bearing, and a cost of processing increases when increasing the planar accuracy of the pinion side slide-contacting surface.

In addition, in a pinion tube shift structure that includes the metal pinion tube in the pinion moving body in addition to the pinion, the following structures have been proposed as a sliding structure of a collar as a holder made of resin and a metal surface.

That is, a flange part having a smaller diameter than that of the pinion is formed onto the pinion tube and a washer is contacted to an end surface of the flange part, and then the collar is contacted to an end surface of the washer opposite to the flange part.

Thereby, the end surface of the washer is used as a contacting surface with the collar (holder) instead of the pinion side slide-contacting surface (refer to Japanese Patent Application Laid-Open Publication No.2013-083178, for example).

In this case, a rotating speed difference arises between the end surface of the flange part and the washer, and further, a rotating speed difference also arises between the washer and the collar, thus the frictional torque that acts on the collar decreases.

However, since a mass of the pinion moving body in the pinion tube shift structure is large in the first place, the electromagnetic switch needs to be enlarged.

Moreover, an inner circumference of the washer contacts a perimeter of the pinion tube, and frictional torque also occurs between the inner circumference of the washer and the perimeter of the pinion tube, therefore there is a possibility that the reduction effect of the frictional torque by the insertion of the washer may be spoiled in the Publication No. '178.

### SUMMARY

An aspect provides a starter that adopts a pinion shift structure can reduce wear caused by a slide-contacting rotation of a holder without raising costs of parts and processing.

In a starter according to a first aspect, the starter includes a pinion that transmits torque from electric motor to a ring gear of an internal-combustion engine, and a shift lever rotated by an electromagnetic switch for engaging the pinion to the ring gear.

The pinion has teeth that engage with the ring gear and a cylindrical portion that extends in a direction opposite to the ring gear relative to the teeth in an axial direction.

The starter further includes a resin holder integrated with the pinion relatively rotatable to the pinion at an opposite end to the ring gear in the axial direction.

The resin holder is movable in the axial direction with the pinion, the resin holder is supporting an end of a shift lever.

The starter further includes a washer sandwiched in the axial direction by the pinion and the holder.

The washer is supported to form a gap in the radial directions between an outer peripheral surface of the cylindrical portion and the washer.

First, the resin holder is integrated with the pinion relatively rotatable to the pinion at the end side opposite to the ring gear in the axial direction, and with supporting the lever end of the shift lever, the holder moves in the axial direction with the pinion.

Moreover, the washer is sandwiched in the axial direction by the pinion and the holder, and the washer is supported forming the gap in the radial directions between the outer peripheral surface of the cylindrical portion and the washer.

According to such a structure, in the starter that adopts the pinion shift structure, wear caused by the slide-contacting rotation of the holder can be reduced without raising costs of parts and processing.

That is, although the washer is inexpensive, it has high planar accuracy.

Then, by sandwiching the washer with the pinion and the holder in the axial direction, a metal surface of the inexpensive washer with high planar accuracy can be used as a contacting surface that directly contacts the resin surface which is the holder side slide-contacting surface.

Furthermore, the metal surface of the inexpensive washer with high planar accuracy can be directly contacted also to the metal surface which is the pinion side slide-contacting surface.

Moreover, since the washer is relatively rotatable to both the pinion and the holder, a rotating speed difference arises between the pinion and the washer, and another rotating speed difference also arises between the washer and the holder.

For this reason, the rotating speed difference between the washer and the holder becomes smaller than the rotating speed difference that has arisen between the holder side slide-contacting surface and the pinion side slide-contacting surface in the conventional pinion shift structure.

As a result, the frictional torque that the holder side slide-contacting surface receives by the slide-contacting rotation can be reduced.

Accordingly, in the starter that adopts the pinion shift structure, wear caused by the slide-contacting rotation of the holder can be reduced without raising costs of parts and processing.

In the starter according to a second aspect, among surfaces of the holder, a contacting surface that faces or contacts to an end surface of the washer in the axial direction has a smaller diameter than an outer diameter of the washer.

In the starter according to a third aspect, an outer diameter of the pinion is smaller than an outer diameter of the washer.

In the starter according to a fourth aspect, an inner diameter of the washer is larger than an outer diameter of the cylindrical portion.

In the starter according to a fifth aspect, the pinion has a tooth bottom at a side opposite to the ring gear in the axial direction that blends to the teeth, and an end surface of the tooth bottom at the side opposite to the ring gear forms a contacting surface that faces or contacts to one of end surfaces of the washer in the axial direction.

The cylindrical portion is extended from the tooth bottom away from the ring gear in the axial direction.

In an outer peripheral surface of the cylindrical portion, a predetermined range in the axial direction that blends from the contacting surface has a diameter that increases as it approaches as it approaches the contacting surface, and is a taper-shaped curved surface that recesses toward an inner circumference side.

The inner circumference of the washer contacts a part of the curved surface and is held by the part of the curved surface.

In the starter according to a sixth aspect, a plurality of washers is provided.

### BRIEF DESCRIPTION OF THE DRAWINGS

In the accompanying drawings:

FIG. 1 shows an overall block diagram of a starter (first aspect);

FIG. 2A shows a block diagram of a pinion moving body (first aspect);

FIG. 2B is an enlarged part of FIG. 2A, and shows a block diagram of a principal part of the starter (first aspect);

FIG. 3 shows a block diagram of a principal part of the starter (second aspect);

FIG. 4 shows a block diagram of a principal part of the starter (third aspect);

FIG. 5 shows a block diagram of a principal part of the starter (fourth aspect);

FIG. 6 shows a block diagram of a principal part of the starter (fifth aspect);

FIG. 7 shows a block diagram of a principal part of the starter (sixth aspect);

FIG. 8 shows a block diagram of a principal part of the starter before pushing out the pinion moving body (seventh aspect);

FIG. 9 shows a block diagram of the principal part of the starter after pushing out the pinion moving body (seventh aspect);

FIG. 10 shows a block diagram of a principal part of the starter (eighth aspect);

FIG. 11 shows a block diagram of a principal part of the starter (first modification);

FIG. 12 shows a block diagram of a principal part of the starter (second modification); and

FIG. 13 shows a sectional view taken along a line XIII-XIII of FIG. 12 (second modification).

### DETAILED DESCRIPTION OF THE PREFERABLE ASPECTS

Hereinafter, aspects of the present disclosure are explained with reference to the drawings.

### Aspects

### Composition of First Aspect

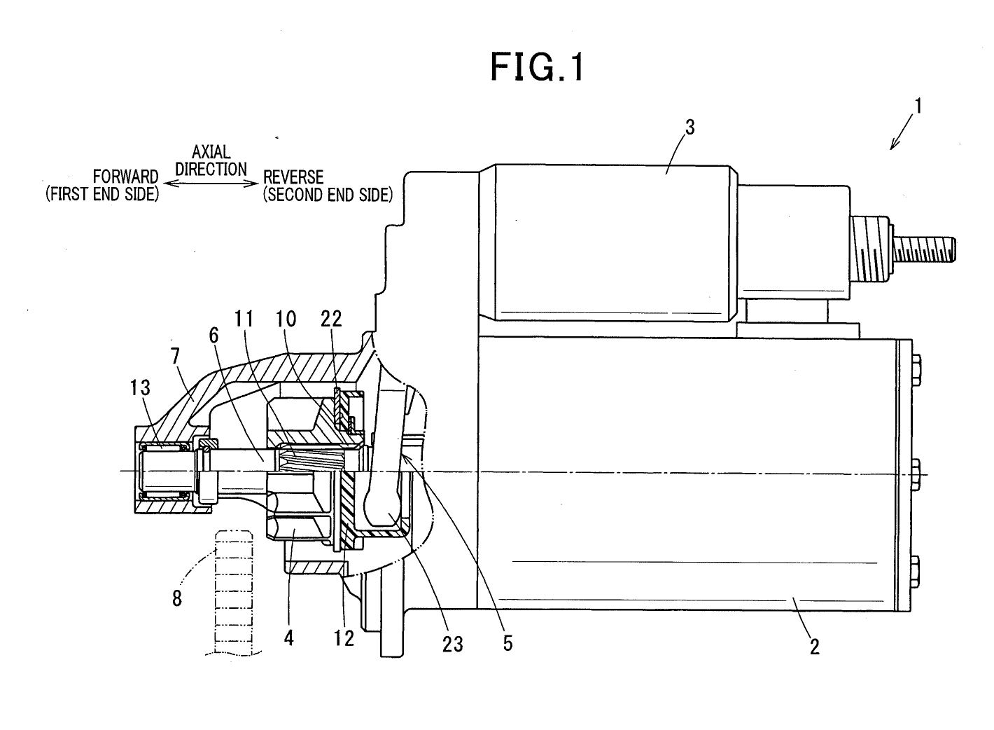

The composition of a starter 1 of the first aspect is explained using FIG. 1.

The starter 1 is installed in an engine compartment of a vehicle (not shown), and starts an internal-combustion engine (not shown).

The starter 1 has an electric motor 2, an electromagnetic switch 3, a pinion 4, a shift lever 5, a drive shaft 6, a housing 7, a one-way clutch (not shown), and the like.

Hereinafter, a side where the pinion 4 is disposed is defined as a first end side in an axial direction while a side where the electric motor 2 is disposed is defined as a second end side in the axial direction as shown in the drawings.

In the starter 1, the shift lever 5 is shifted by the electromagnetic switch 3 to engage the pinion 4 to a ring gear 8 of the engine, and a torque of the electric motor 2 is transmitted to the ring gear 8 via the pinion 4 to start the engine.

Here, the electric motor 2 is a commonly known direct current motor that generates torque to start the engine, and has an armature, a magnetic field system, a brush, a commutator, and the like.

Moreover, the electromagnetic switch 3 has a commonly known structure of a coil, a moving contact, a fixed contact, and the like, and displaces the pinion 4 forward in an axial direction so as to contact and engage with the ring gear 8 by a switch-on operation of a driver, and also energizes the electric motor 2.

Moreover, the drive shaft 6 is disposed coaxially with an output shaft of the electric motor 2, and the pinion 4 is fitted to the drive shaft 6 through a helical spline.

That is, a female helical spline 10 and a male helical spline 11 are formed in an inner circumference of the pinion 4 and a perimeter of the drive shaft 6, respectively, and the male helical spline 10 and the female 11 helical spline are engaged.

Moreover, the shift lever 5 is supported rotatably by the housing 7 around a fulcrum.

One end of the shift lever 5 is held at the pinion 4 side (supported by a holder 12 mentioned later), and another end is linked to the electromagnetic switch 3.

Thereby, the shift lever 5 pushes the pinion 4 forward in the axial direction by an operation of the electromagnetic switch 3, and returns the pinion 4 in the axial direction when the electromagnetic switch 3 stops its operation.

Moreover, the drive shaft 6 is rotated by a torque transmitted from the electric motor 2 through planetary-reduction gears (not shown) , for example, and is disposed coaxially with the output shaft of the electric motor 2.

Furthermore, the housing 7 accommodates the pinion 4, the drive shaft 6 and the like, and forms a part of outline of the starter 1.

Moreover, a bearing 13 that supports a distal end of the drive shaft 6 rotatably is accommodated at a distal end of the housing 7.

In addition, the one-way clutch has a commonly known structure that permits the torque of the electric motor 2 to be transmitted to the ring gear 8 through the drive shaft 6 and the pinion 4, and intercepts a torque of the engine to be transmitted from the drive shaft 6 to the output shaft of the electric motor 2 by racing after starting of the engine.

With the above composition, in the starter 1, when the electromagnetic switch 3 operates by a switch-on operation of the driver, the shift lever 5 is driven to rotate so that the pinion 4 and the holder 12 move forward in the axial direction unitarily, while the electric motor 2 is turned on by energization and the electric motor 2 starts to output the torque.

Thereby, the pinion 4 contact to the ring gear 8 and engages with it, and the ring gear 8 is rotated by the torque of the electric motor 2 and the engine starts.

Moreover, after the engine has started, when the ring gear 8 starts rotating at high speed, the pinion 4 and the drive shaft 6 also start rotating at high speed and the one-way clutch races, thus the transfer of the torque between the drive shaft 6 and the electric motor 2 is shut off.

Meanwhile, when the electromagnetic switch 3 stops its operation, the shift lever 5 is driven to rotate in a return direction of the pinion 4 so that the pinion 4 returns in the axial direction, and the pinion 4 is disengaged from the ring gear 8.

Moreover, the energization to the electric motor 2 is turned off, and the electric motor 2 stops outputting the torque.

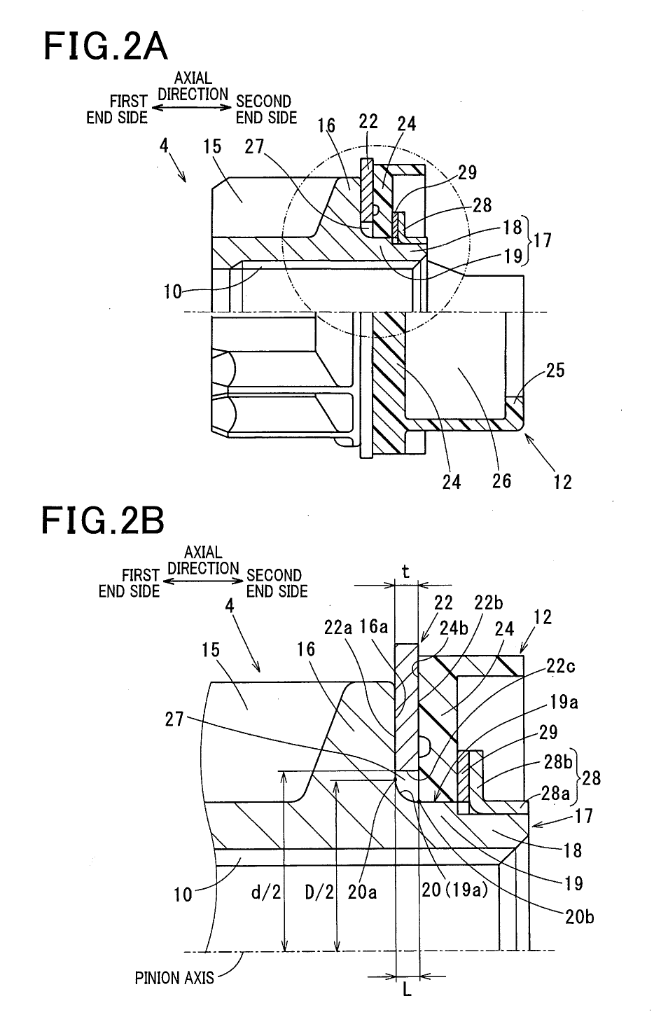

Hereinafter, a characteristic composition of the starter 1 is explained using FIG. 2A and FIG. 2B.

First, the pinion 4 has teeth 15 having tips that substantially engage with the ring gear 8, and the teeth 15 are formed by cutting out with a die in the first end side during cold forging.

Moreover, a flange-shaped portion that blends in the second end side of the teeth 15 is a portion that is not cut out during cold forging when forming the tips of the teeth 15, and forms a tooth bottom 16.

Furthermore, the pinion 4 has a cylindrical portion 17 extending in the second end side from the tooth bottom 16.

Moreover, the cylindrical portion 17 has steps, and a step in the second end side has a smaller diameter than that of a step in the first end side (in the cylindrical portion 17, the steps in the second end side and the first end side are hereafter called a small diameter part 18 and a large diameter part 19, respectively.).

The cylindrical portion 17 is formed by cutting out with a die in the second end side during cold forging.

For this reason, in an outer peripheral surface 19a of the large diameter part 19, a predetermined portion in the axial direction that blends from an end surface 16a in the second end side of the tooth bottom 16 has a large diameter as it approaches the end surface 16a, and the predetermined portion has a taper-shaped curved surface 20 that recesses toward an inner circumference side.

The curved surface 20 blends smoothly from the outer peripheral surface 19a and the end surface 16a.

In addition, in the following explanation, a first end in the axial direction (i.e., connecting portion of the end surface 16a and the curved surface 20) of the curved surface 20 is called a first end curved surface 20a, and a second end in the axial direction (i.e., connecting portion of the outer peripheral surface 19a other than the curved surface 20 and the curved surface 20) of the curved surface 20 is called a second end curved surface 20b.

The starter 1 has the following holder 12 and a washer 22 as characteristic components.

First, the holder 12 is a component made of resin to support an end of the shift lever 5 (refer to FIG. 1. Hereinafter, it may be called a lever end 23.), and is integrated with the pinion 4 by being fit into the large diameter part 19 of the cylindrical portion 17.

In addition, the holder 12 is fit relatively rotatable to the pinion 4, and it is dispose in the second end side of the tooth bottom 16.

Moreover, the holder 12 has first and second end side regulators 24 and 25, and a rotation regulator 26.

The lever end 23 is accommodated in a space formed by the first and second end side regulators 24 and 25, and the rotation regulator 26.

Here, the first second end side regulators 24 and 25 are portions that regulate a movement of the lever end 23 in the axial direction by contacting the lever end 23, and a fitting hole through which the cylindrical portion 17 passes is formed in the first end side regulator 24.

Moreover, the rotation regulator 26 regulates a self-rotation of the holder 12, and is disposed so as to bridge across the first and the second end side regulators 24 and 25 in the axial direction, and it is positioned at a outer peripheral surface of the lever end 23.

When the holder 12 tends to rotate, the rotation regulator 26 hits the lever end 23, thereby the rotation of the holder 12 is regulated.

Next, the washer 22 is disposed between the pinion 4 and the holder 12, and is sandwiched and held by the pinion 4 and the holder 12 in the axial direction.

That is, a metal surface 22a in the first end side of the washer 22 contacts the end surface 16a of the tooth bottom 16.

In other words, the end surface 16a forms a contacting surface that contacts with the washer 22 (the end surface 16a is hereafter called the metal surface 16a).

Moreover, a metal surface 22b in the second end side of the washer 22 contacts an end surface of the first end side regulator 24 in the axial direction.

That is, in the holder 12, the end surface of the first end side regulator 24 in the axial direction forms a contacting surface that contacts with the washer 22 in the axial direction (the end surface of the first end side regulator 24 in the axial direction is hereafter called a resin surface 24b.).

The large diameter part 19 of the cylindrical portion 17 passes through the washer 22, and the washer 22 is supported by the large diameter part 19 forming a gap 27 in a radial direction therebetween.

Moreover, an outer diameter of the washer 22 is larger than an outer diameter of the metal surface 16a, and is larger than an outer diameter of the resin surface 24b.

Furthermore, an inner diameter d of the washer 22 is larger than an outer diameter of the large diameter part 19, and an inner diameter d of the washer 22 is also larger than a diameter of the first end curved surface 20a, i.e., a maximum diameter D of the curved surface 20.

Here, in the first aspect, an axial distance between the first end curved surface 20a and the second end curved surface 20b, i.e., an axial length L of the curved surface 20 is equal to a thickness t of the washer 22.

The washer 22 is assembled into the pinion 4 coaxially, and a radial distance between an inner circumference surface 22c of the washer 22 and the first end curved surface 20a is constant and given the value d/2-D/2.

Moreover, a total area of the inner circumference surface 22c is separated from the curved surface 20 by the gap 27.

In addition, a metal regulation member 28 is press-fit to the small diameter part 18 of the cylindrical portion 17.

Here, the regulation member 28 regulates that the holder 12 and the washer 22 not to separate from the cylindrical portion 17 to the second end side direction.

Moreover, the regulation member 28 has a cylinder part 28a that is press-fit to the small diameter part 18, and a flange part 28b that is formed in the first end side of the cylinder part 28a.

Another washer 29 is disposed also between the flange part 28b and the first end side regulator 24, and another gap is formed between an inner circumference surface of the washer 29 and an outer peripheral surface of the small diameter part 18.

Accordingly, the holder 12, the washer 22, the regulation member 28, and the washer 29 together with the pinion 4 constitute the pinion moving body driven by the shift lever 5.

For this reason, the starter 1 has the pinion shift structure that does not include a metal pinion tube in the pinion moving body, and has the holder 12 made of resin to make it lightweight.

When the shift lever 5 is rotated by the operation of the electromagnetic switch 3, the lever end 23 pushes the holder 12 towards the first end side in the axial direction, then the holder 12 pushes the washer 22 towards the first end side and the washer 22 pushes the pinion 4 towards the first end side so that the pinion moving body is united and moves forward in the axial direction.

Thereby, the pinion 4 contacts the ring gear 8 and engages with it, then the ring gear 8 is rotated by the torque of the electric motor 2 and the internal-combustion engine is therefore started.

Moreover, when the electromagnetic switch 3 stops its operation after starting of the engine, the shift lever 5 is rotated in the direction opposite to the rotation at the time of advancing the pinion moving body.

Thereby, the lever end 23 pushes the holder 12 towards the second end side, and the holder 12 pushes the regulation member 28 towards the second end side through the washer 29 so that the pinion moving body is united and returns in the axial direction.

Thereby, the pinion 4 disengages from the ring gear 8.

Moreover, when ring gear 8 rotates at high speed due to the starting of the engine and the pinion 4 therefore rotates at high speed, a slide-contacting rotation will occur either between the metal surface 16a and the metal surface 22a, or between the resin surface 24b and the metal surface 22b, or both.

That is, when the pinion 4 rotates, the metal surface 16a becomes the pinion side slide-contacting surface and rotates and slide-contacts the metal surfaces 22a, or the resin surface 24b becomes the holder side slide-contacting surface and rotates and slide-contacts the metal surfaces 22b.

Moreover, since the regulation member 28 is press-fit into the small diameter part 18, the slide-contacting rotation occurs either between the flange part 28b and the washer 29, or between the first end side regulator 24 and the washer 29, or between the flange part 28b and the washer 29 and between the first end side regulator 24 and the washer 29 when the pinion 4 rotates.

In addition, since the gap is formed between the inner circumference surface of the washer 29 and the outer peripheral surface of the small diameter part 18, the slide-contacting rotation does not occur between the inner circumference surface of the washer 29 and the outer peripheral surface of the small diameter part 18.

Further, an amount of the frictional torque between the pinion 4, the washer 22, and the holder 12 is configured by press-fitting of the regulation member 28 to the small diameter part 18.

### The Effect of the First Aspect

According to the starter 1 of the first aspect, the holder 12 is made of resin, is integrated with the pinion 4 relatively rotatable at the second end side in the axial direction of the pinion 4, and with the holder 12 supporting the lever end 23 of the shift lever 5, the holder 12 moves in the axial direction with the pinion 4.

Moreover, the washer 22 is sandwiched in the axial direction by the pinion 4 and the holder 12, and is supported forming the gap 27 in the radial directions between the washer 22 and the outer peripheral surface 19a of the cylindrical portion 17.

According to such a structure, in the starter 1 that adopts the pinion shift structure, wear caused by the slide-contacting rotation of the holder 12 can be reduced without raising costs of parts and processing.

That is, although the washer 22 is inexpensive, it has high planar accuracy.

Then, by sandwiching the washer 22 with the pinion 4 and the holder 12 in the axial direction, the metal surface 22b of the washer 22 with high planar accuracy can be used as a contacting surface that directly contacts the resin surface 24b which is the holder side slide-contacting surface.

Furthermore, the metal surface 22a of the washer 22 with high planar accuracy can be directly contacted also to the metal surface 16a which is the pinion side slide-contacting surface.

Moreover, since the washer 22 is relatively rotatable to both the pinion 4 and the holder 12, a rotating speed difference arises between the pinion 4 and the washer 22, and another rotating speed difference also arises between the washer 22 and the holder 12.

For this reason, the rotating speed difference between the washer 22 and the holder 12 becomes smaller than the rotating speed difference that has arisen between the holder side slide-contacting surface and the pinion side slide-contacting surface in the conventional pinion shift structure.

As a result, the frictional torque that the resin surface 24b as the holder side slide-contacting surface receives by the slide-contacting rotation can be reduced.

Accordingly, in the starter 1 that adopts the pinion shift structure, wear caused by the slide-contacting rotation of the holder 12 can be reduced without raising costs of parts and processing.

For example, wear caused by the slide-contacting rotation of the holder 12 can be reduced without raising processing cost by building the pinion 4 into the starter 1 without requiring extra processing of the pinion side slide-contacting surface (metal surface 16a) for raising planar accuracy, but using it as it is with a forged surface.

Moreover, the holder side slide-contacting surface (resin surface 24b) has a smaller outer diameter than that of the washer 22, and the outer diameter of the pinion 4 is smaller than that of the washer 22.

Accordingly, by raising an inertial moment of the washer 22 by expanding the diameter of the washer 22, entrainment of the washer 22 accompanying the rotation of the pinion 4 can be suppressed.

Therefore, the slide-contacting rotation of the resin surface 24b and the metal surface 22b is eased.

As a result, wear by the slide-contacting rotation of the holder 12 can further be reduced.

Here, since the inertia moment increases in proportion to the square of a turning radius, the suppression effect of the entrainment of the washer 22 by expanding the diameter of the washer 22 is very effective in heightening the wear reduction effect of the holder 12.

In addition, although the inertia moment can be raised also by increasing masses, a mass of the pinion moving body will increase if a mass of the washer 22 is increased, and a load to the electromagnetic switch 3 will become large.

On the other hand, since the inertia moment can be raised while suppressing the increase in mass by expanding the diameter of the washer 22, the inertia moment of the washer 22 can be raised and the wear reduction effect of the holder 12 can be heightened while suppressing the increase in the load to the electromagnetic switch 3.

Moreover, the inner diameter of the washer 22 is larger than the diameter of the cylindrical portion 17 (curved surface 19).

By this, the perimeter of the cylindrical portion 17 can be avoided from contacting the inner circumference of the washer 22.

For this reason, the washer 22 can be prevented from receiving the frictional torque from the cylindrical portion 17.

### Second Aspect

It should be appreciated that, in the second aspect and the subsequent aspects, components identical with or similar to those in the first aspect are given the same reference numerals, and structures and features thereof will not be described in order to avoid redundant explanation.

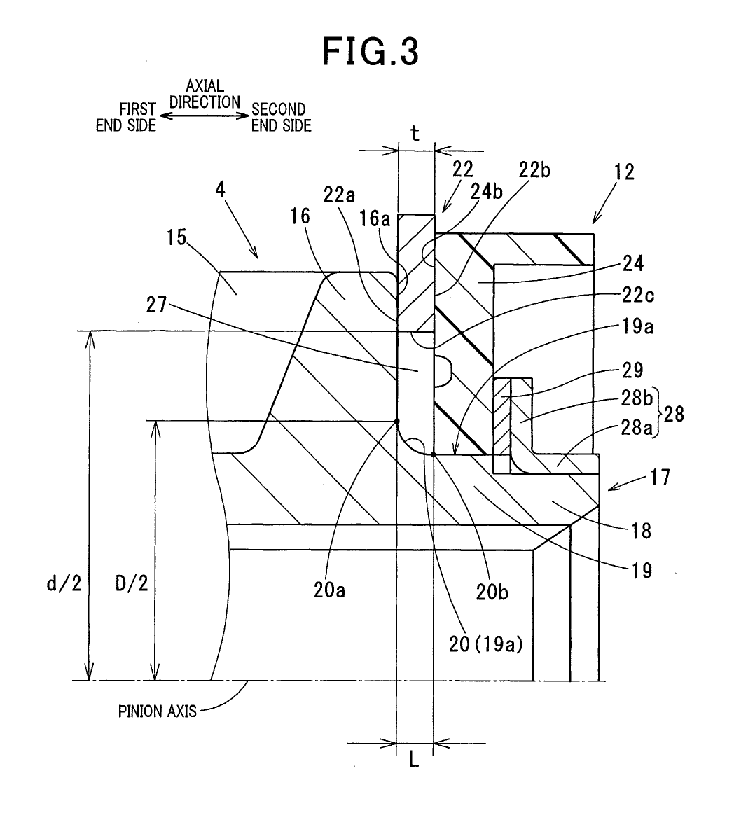

According to the starter 1 of the second aspect, as shown in FIG. 3, the inner diameter d of the washer 22 is larger relative to that of the starter 1 in the first aspect, and the inner circumference surface 22c is further separated from the curved surface 20 towards the outer peripheral surface, thus the gap 27 is expanded.

That is, in the starter 1 of the second aspect, by expanding the inner diameter d of the washer 22, a mass is reduced while suppressing a fall of the inertia moment, and a mass of the pinion moving body is decreased so that the load to the electromagnetic switch 3 is reduced.

### Third Aspect

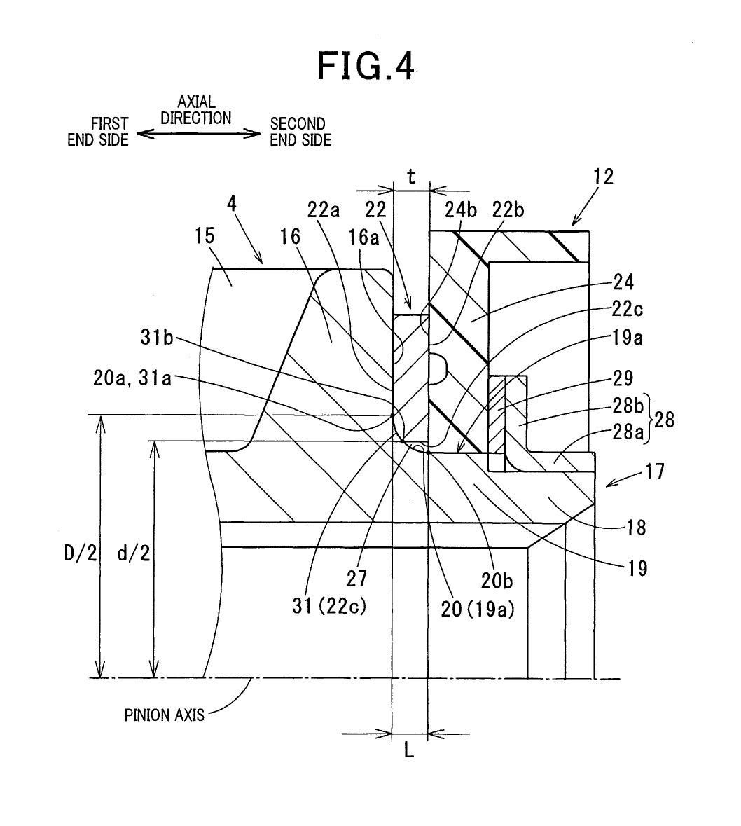

According to the starter 1 of the third aspect, as shown in FIG. 4, the inner diameter d of the washer 22 is smaller than the maximum diameter D of the curved surface 20.

Moreover, a portion near a corner including the first end among the inner circumference surface 22c of the washer 22 is formed so as to expand the diameter as it approaches to the first end side, and is formed as a curved surface 31 projecting toward the inner circumference side.

Furthermore, the curved surface 31 is connected to the metal surface 22a smoothly.

In addition, in the following explanation, a first end in the axial direction (i.e., connecting portion of the metal surface 22a and the curved surface 31) of the curved surface 31 is called a first end curved surface 31a, and second end in the axial direction of the curved surface 31 is called a second end curved surface 31b.

The first end curved surface 31a matches the first end curved surface 20a in the state where the washer 22 is attached.

Moreover, according to the starter 1 of the third aspect, the outer diameter of the washer 22 is smaller than that of the metal surface 16a, and is smaller than that of the resin surface 24b.

### Fourth Aspect

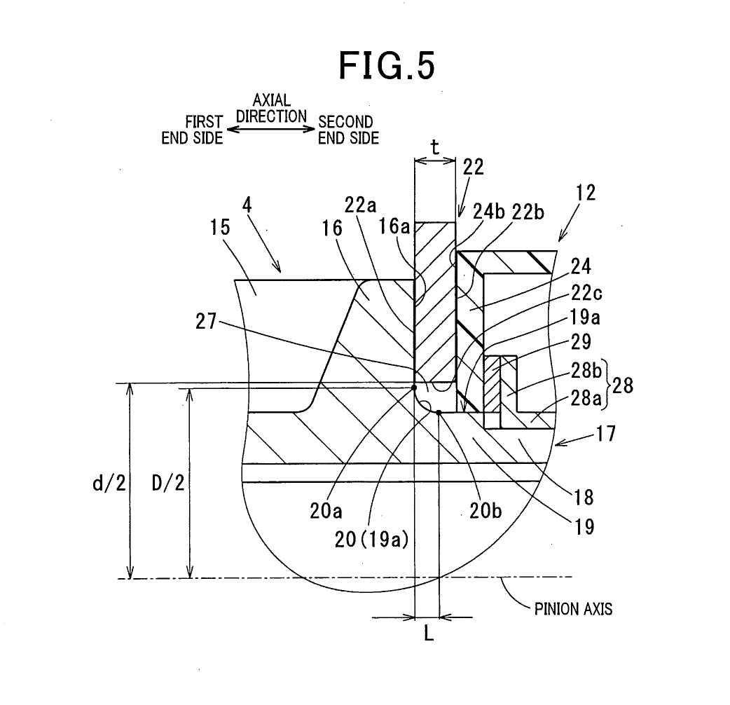

According to the starter 1 of the fourth aspect, as shown in FIG. 5, the thickness t of the washer 22 is larger than an axial length L of the curved surface 20.

For this reason, the gap 27 is expanded towards the second end side compared with that of the first aspect, and the inner circumference surface 22c also forms the gap 27 between the outer peripheral surface 19a other than the curved surface 20.

Moreover, the inertia moment of the washer 22 is higher than that of the first aspect by expanding the thickness to increase the mass.

In addition, the inner diameter d of the washer 22 is larger than the maximum outer diameter D of the curved surface 20.

Moreover, the outer diameter of the washer 22 is larger than the outer diameter of the metal surface 16a, and is larger than the outer diameter of the resin surface 24b.

### Fifth Aspect

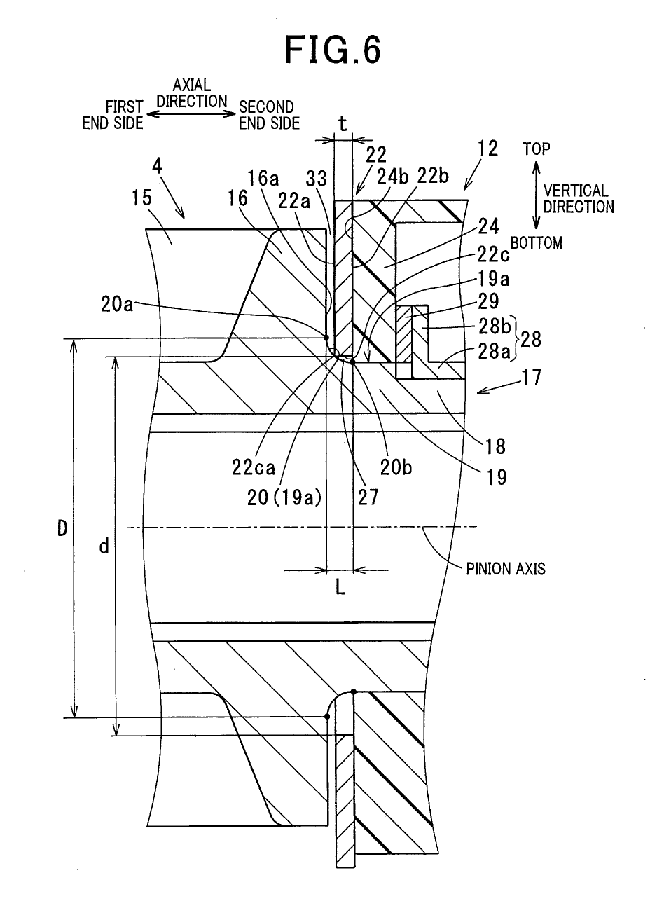

According to the starter 1 of the fifth aspect, as shown in FIG. 6, the thickness t of the washer 22 is smaller than the axial length L of the curved surface 20.

For this reason, above an axis of the pinion 4 in a vertical direction, a first end of the inner circumference surface 22c (hereafter referred to as a first end inner circumference 22ca) contacts the curved surface 20, and the whole inner circumference surface 22c is distant from the curved surface 20 below the axis of the pinion 4.

Moreover, a gap 33 is formed in the axial direction between the metal surface 16a and the metal surface 22a.

Then, when the shift lever 5 is rotated by the operation of the electromagnetic switch 3, the lever end 23 pushes the holder 12 towards the first end side, and further the holder 12 pushes the washer 22 towards the first end side in the axial direction.

Thereby, the gap 33 is shortened, and the washer 22 moves forward in the axial direction to the position it becomes impossible to move while running onto the curved surface 20.

In the meantime, the washer 22 pushes the pinion 4 towards the first end side through a contact of the first end inner circumference 22ca to the curved surface 20.

Then, since the slide-contacting rotation between the pinion 4 and the washer 22 occurs only between the first end inner circumference 22ca and the curved surface 20 when the pinion 4 rotates, the frictional torque that the washer 22 receives from the pinion 4 is reduced sharply.

In addition, in the fifth aspect, since the thickness t of the washer 22 is smaller than the axial length L of the curved surface 20, the mass of the washer 22 becomes small.

For this reason, since the mass of the pinion moving body becomes small, it is advantageous when miniaturizing the electromagnetic switch 3.

### Sixth Aspect

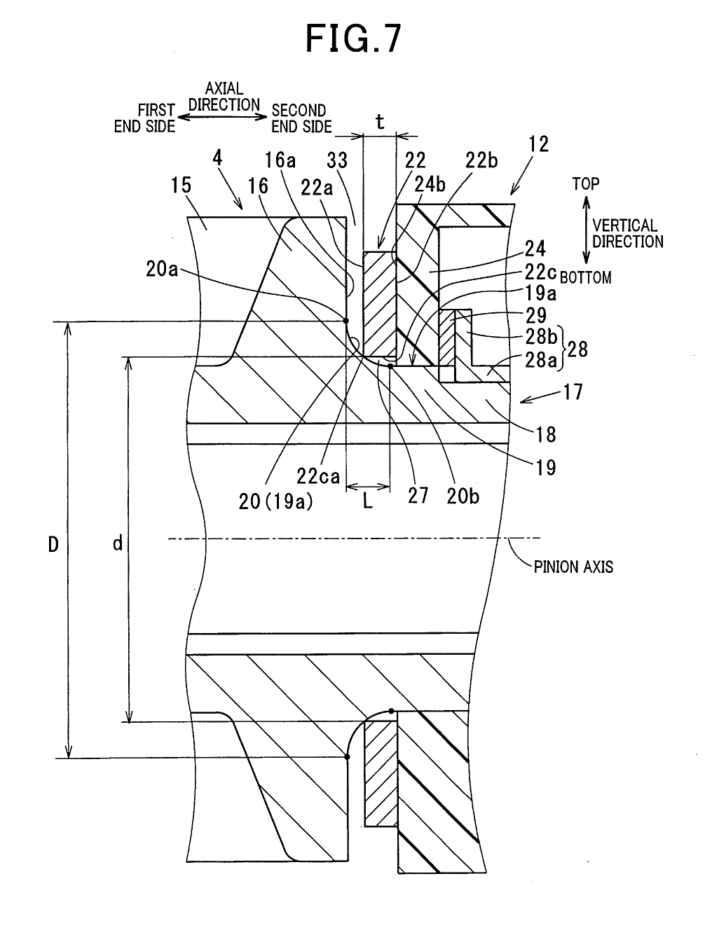

According to the starter 1 of the sixth aspect, as shown in FIG. 7, the thickness t of the washer 22 is smaller than the axial length L of the curved surface 20.

Moreover, the inner diameter d of the washer 22 is smaller than the maximum outer diameter D of the curved surface 20.

For this reason, the gap 33 is formed in the axial direction between the metal surface 16a and the metal surface 22a.

Moreover, according to the starter 1 of the sixth aspect, unlike the starter 1 of the fifth aspect, the first end inner circumference 22ca touches the curved surface 20 both above and below the axis of the pinion 4 in the vertical direction.

Thereby, even when the electromagnetic switch 3 is operated, the gap 33 does not get shortened, but the pinion 4 is pushed towards the first end side by the washer 22 by the contact of the first end inner circumference 22ca and the curved surface 20, and moves forward in the axial direction.

Moreover, since the slide-contacting rotation between the pinion 4 and the washer 22 occurs only between the first end inner circumference 22ca and the curved surface 20 when the pinion 4 rotates, the frictional torque that the washer 22 receives from the pinion 4 is reduced sharply.

By this, while the frictional torque that the washer receives from the cylindrical portion is minimized, the washer can be held in the radial direction by the curved surface.

### Seventh Aspect

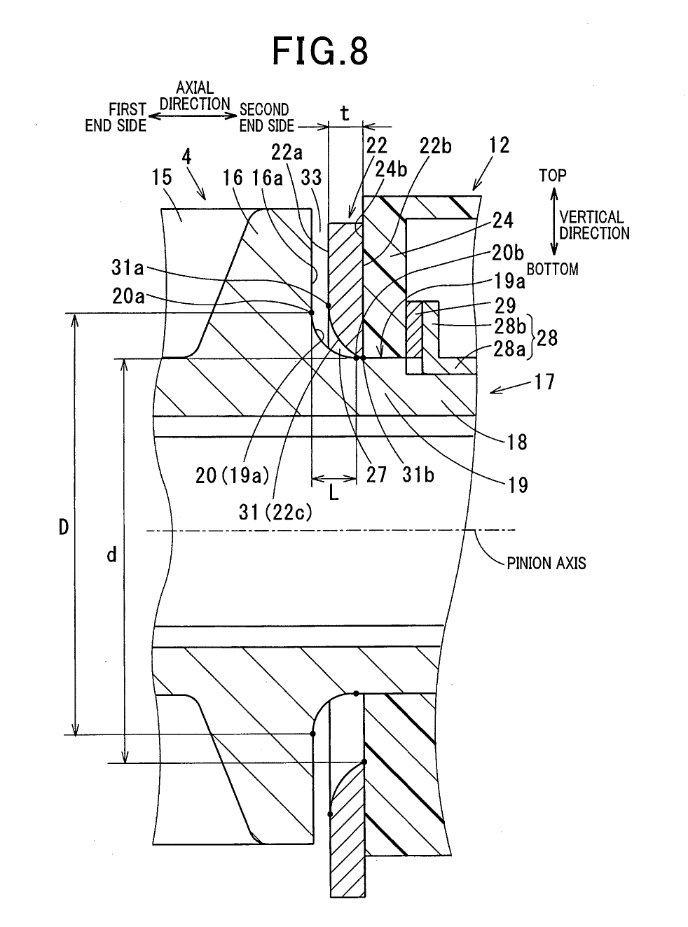

According to the starter 1 of the seventh aspect, as shown in FIG. 8, the thickness t of the washer 22 is smaller than the axial length L of the curved surface 20.

Moreover, the inner circumference surface 22c of the washer 22 does not have a cylindrical portion but the curved surface 31, and blends smoothly with the metal surface 22a, while the second end curved surface 31b matches with an inner circumference edge of the metal surface 22b.

Further, the washer 22 contacts the outer peripheral surface 19a by the second end curved surface 31b above the axis of the pinion 4 in a vertical direction, and the entire inner circumference surface 22c (curved surface 31) is separated from the inner circumference surface 19a below the axis of the pinion 4.

Moreover, the inner diameter d of the washer 22 is a diameter of the second end curved surface 31b, and the inner diameter d is smaller than the maximum outer diameter D of the curved surface 20.

Moreover, the diameter of the curved surface end 31a is larger than the maximum outer diameter D, and the curved surface end 31a is positioned in an outer peripheral surface side from the first end curved surface 20a above the axis of the pinion 4 in a vertical direction.

Furthermore, a curvature radius of the inner circumference surface 22c (curved surface 31) is larger than a curvature radius of the curved surface 20 in a section that is parallel in the vertical direction and that includes the axis of the pinion 4.

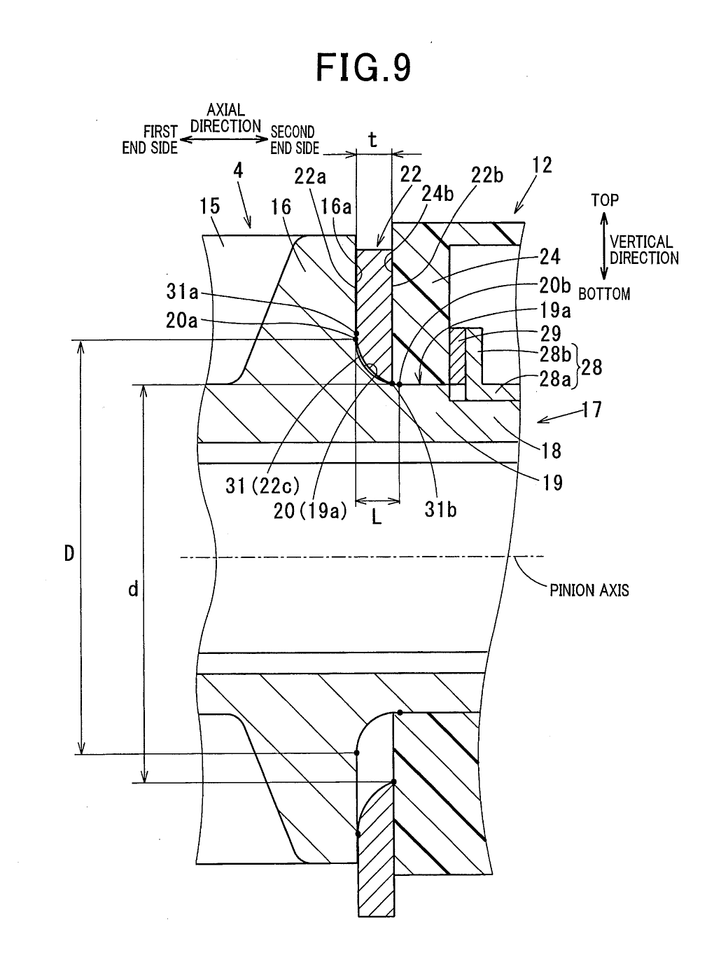

Then, when the shift lever 5 is rotated by the operation of the electromagnetic switch 3, as shown in FIG. 9, the gap 33 gets shortened and the metal surface 22a abuts the metal surface 16a by the holder 12 pushing the washer 22 towards the first end side.

Moreover, the washer 22 moves forward in the axial direction while the second end curved surface 31b runs onto the curved surface 20 until the metal surface 22a abuts the metal surface 16a.

In addition, in the holder 12, the fitting hole formed in the first end side regulator 24 is slightly expanded near the first end compared with other portions, and the resin surface 24b can move towards the first end side in the axial direction farther than to the second end curved surface 22b.

Further, the metal surface 16a rotates and slide-contacts the metal surface 22a when the pinion 4 rotates, and the inner circumference surface 22 receives slide-contacting rotation of the curved surface 20 only in the second end curved surface 31b.

Therefore, although the washer 22 receives frictional torque in the radial direction from the pinion 4 in addition to the axial direction, the frictional torque received in the radial direction is limited to what is received in the second end curved surface 31b, and does not become so large.

Moreover, according to the starter 1 of the seventh aspect, while forming the entire inner circumference surface 22c into the curved surface 31, the curvature radius of the inner circumference surface 22c (curved surface 31) is made larger than the curvature radius of the curved surface 20, and the inner circumference surface 22c and the outer peripheral surface 19a only contact through the second end curved surface 31b.

Thereby, when a running onto the curved surface 20 arises, the wear of a portion that runs onto the curved surface 20 can be suppressed.

For this reason, even when the running onto the curved surface 20 arises, a change in a pushing amount of the pinion 4 by the shift lever 5 (advancing distance in the axial direction) can be suppressed.

In addition, in order to prevent the washer 22 running onto the curved surface 20 even when the thickness t of the washer 22 is small, it is also can be considered directing to reduce the curvature-radius of the curved surface 20 according to the thickness t.

However, when reducing the curvature radius by cutting, a cutting tool is easily worn out and it is necessary to lower machining speed.

Moreover, in cold forging, it is necessary to raise processing load as the curvature radius is smaller, thus a die life becomes short.

For this reason, it is not desirable to reduce the curvature radius of the curved surface 20 for preventing the washer 22 from running onto the curved surface 20.

### Eighth Aspect

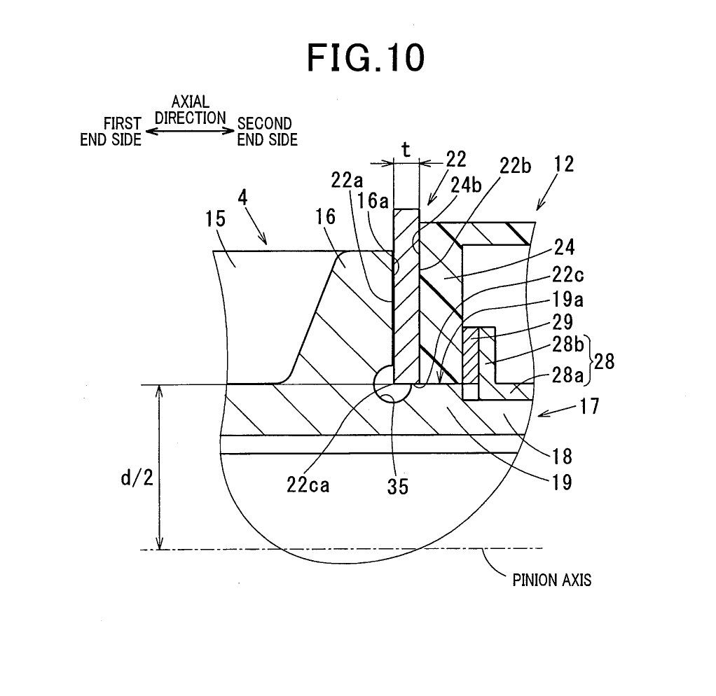

According to the starter 1 of the eighth aspect, as shown in FIG. 10, in the pinion 4, between the metal surface 16a and the outer peripheral surface 19a is scooped toward the inner circumference surface to form a recess 35, and thus the curved surface 20 does not exist.

Moreover, the curved surface 31 is not formed in the inner circumference surface 22c of the washer 22, but the first end inner circumference 22ca is projected into the recess 35.

Furthermore, the inner diameter d of the washer 22 is equal to the outer diameter of the large diameter part 19, and the washer 22 is held by being contacted to the outer peripheral surface 19a of the large diameter part 19 near the recess 35.

Therefore, when the pinion 4 rotates, although the washer 22 receives frictional torque in the radial direction from the large diameter part 19, the frictional torque received in the radial direction will be limited to what is received in the outer peripheral surface 19a of the large diameter part 19 near the recess 35, and will not become so large.

### Modifications

The aspect of the starter 1 is not limited to the aspects mentioned above, but various modifications can be considered.

For example, although the number of sheets of the washer 22 used according to the starter 1 of the aspect is one, a plurality of washers may be used.

Thereby, the size of the pinion moving body in the axial direction and mass can be adjusted by increasing or decreasing the number of sheets of the washer 22.

Moreover, since the rotating speed of the washer 22 that contacts the resin surface 24b among the plurality of washers 22 can be adjusted, wear of the holder 12 can be suppressed more effectively.

Further, a single washer 22 may be provided by stacking in the axial direction a plurality of ring-shaped disks in which an inside diameter or an outer diameter differs.

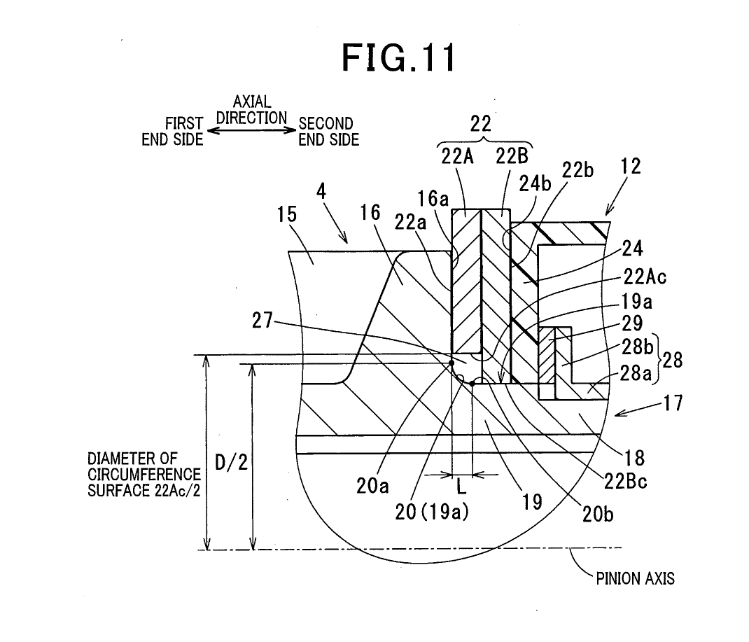

For example, as shown in FIG. 11, two sheets of disks 22A and 22B having the same outer diameters and different inner diameters may be stacked in the axial direction to form the washer 22.

According to FIG. 11, an inner diameter of a circumference surface 22Ac of the disk 22A in the first end side is larger than the maximum outer diameter D of the curved surface 20, and the gap 27 is formed between the outer peripheral surface 19a of the large diameter part 19 and the circumference surface 22Ac of the disk 22A.

Moreover, the disk 22B is loose fit to the cylindrical portion 17. In addition, the disks 22A and 22B may be welded, soldered, etc.

Moreover, the disks 22A and 22B may not be joined, but may be provided as respective individual washers 22.

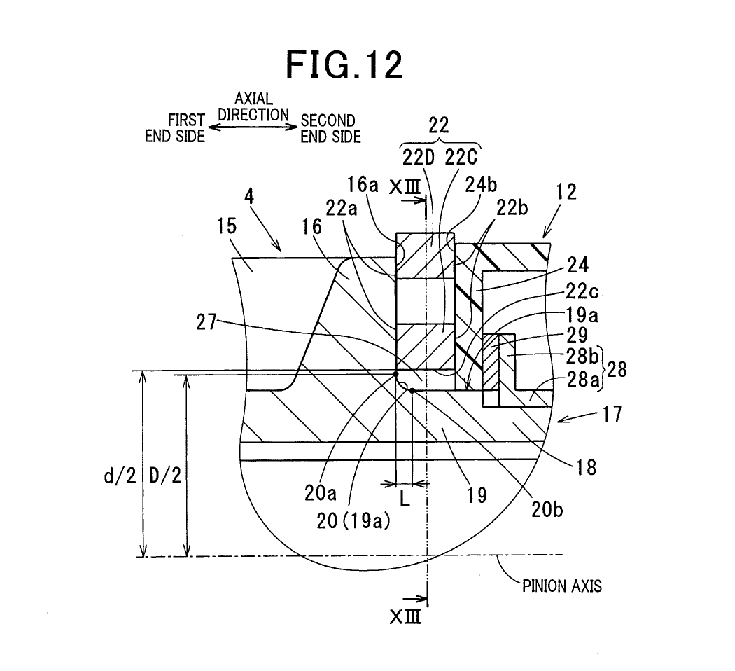

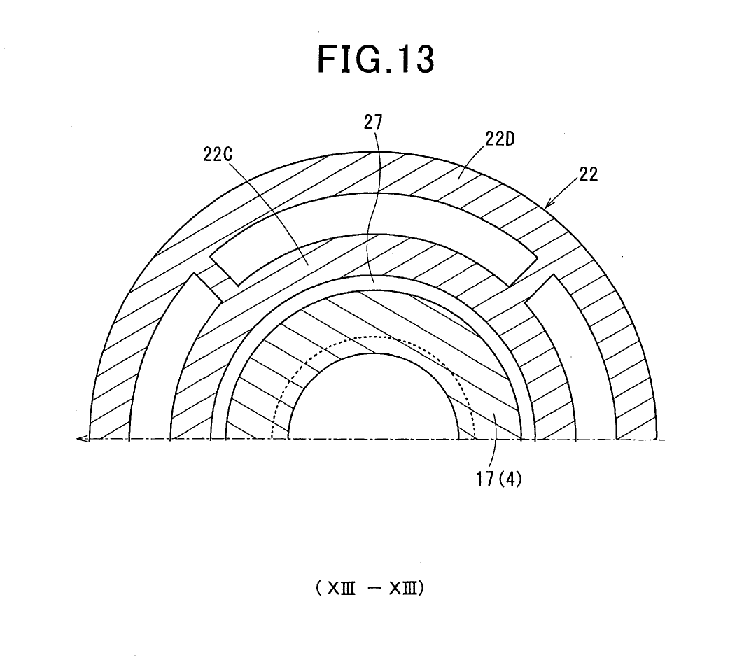

Furthermore, as shown in FIG. 12 and FIG. 13, a single washer 22 may be provided by joining in the radial direction two ring-shaped disks 22C and 22D which have two different inner diameters and outer diameters.

In this case, since areas of the metal surfaces 22a can be limited respectively in a perimeter side and an inner circumference surface side in a radial direction, the frictional torque that the metal surface 22a receives from the metal surface 16a in the axial direction can be suppressed.

What is claimed is:

1. A starter comprising:
a pinion that transmits torque from electric motor to a ring gear of an internal-combustion engine;
a shift lever rotated by an electromagnetic switch for engaging the pinion to the ring gear;
the pinion having teeth that engage with the ring gear and a cylindrical portion that extends in a direction opposite to the ring gear relative to the teeth in an axial direction;
a resin holder integrated with the pinion relatively rotatable to the pinion at an opposite end to the ring gear in the axial direction, and the resin holder being movable in the axial direction with the pinion, the resin holder supporting an end of a shift lever; and
a washer sandwiched in the axial direction by the pinion and the holder, and the washer supported to form a gap in the radial direction between an outer peripheral surface of the cylindrical portion and the washer.

2. In the starter according to claim 1, wherein,
among surfaces of the holder, a contacting surface that faces or contacts to an end surface of the washer in the axial direction has a smaller diameter than an outer diameter of the washer.

3. In the starter according to claim 1, wherein,
an outer diameter of the pinion is smaller than an outer diameter of the washer.

4. In the starter according to claim 1, wherein,
an inner diameter of the washer is larger than an outer diameter of the cylindrical portion.

5. In the starter according to claim 1, wherein,
the pinion has a tooth bottom at a side opposite to the ring gear in the axial direction that blends to the teeth;
an end surface of the tooth bottom at the side opposite to the ring gear forms a contacting surface that faces or contacts to one of end surfaces of the washer in the axial direction;
the cylindrical portion is extended from the tooth bottom away from the ring gear in the axial direction;
in an outer peripheral surface of the cylindrical portion, a predetermined range in the axial direction that blends from the contacting surface has a diameter that increases as it approaches the contacting surface, and is a taper-shaped curved surface that recesses toward an inner circumference side; and
the inner circumference of the washer contacts a part of the curved surface and is held by the part of the curved surface.

6. In the starter according to claim 1, wherein,
a plurality of washers is provided.
